(19) United States
(12) Patent Application Publication
(10) Pub. No.: US 2008/0154797 A1
(43) Pub. Date: Jun. 26, 2008

(54) Hybrid Advertisement Pricing System and Method

(75) Inventor: Lee Choul won, Seoul (KR)

Correspondence Address: Law Office of Mark J. Spolyar, 38 Fountain Street, San Francisco, CA, 94114, US

(73) Assignee: Yahoo! Inc., a Delaware Corporation

(21) Appl. No.: 11/615,521

(22) Filed: Dec. 22, 2006

(30) Foreign Application Priority Data
Dec. 20, 2006 (KR) 10-2006-131122

(51) Int. Cl. G06F 17/00

(52) U.S. Cl. 705/400

(57) ABSTRACT

A hybrid advertisement pricing system and method for determining the price of an advertisement on the Internet is disclosed. The system includes a CPM (Cost-Per-Million impressions) module, a CPC (Cost-Per-Click) module, a price accounting module and a controller. The CPM module is configured to compute a CPM price for an exposure of an advertisement. The price accounting module is configured to compute the price of the advertisement. The CPC module is configured to compute a CPC price for a click on an advertisement based on the CPM price and the CPC price. The controller is configured to control operations of the CPM module, the CPC module and the price accounting module. As such, it is possible to determine the price of an advertisement by computing the price based on both exposure and click based costs while reducing the effect of fraudulent clicks on the price.

### TECHNICAL FIELD

The present disclosure generally relates to determining the price of placing an advertisement on the Internet.

### BACKGROUND

Searching and choosing products and services via Internet-based search engines have become increasingly prolific in recent years. Accordingly, advertising on the Internet is now being considered as an important marketing method. Further, there is a need for a method for determining a reasonable price of placing an advertisement on the Internet.

Cost-per-million impressions (CPM) and cost-per-click (CPC) are two well-known methods for determining the price of an advertisement on the Internet. In the CPM method, an advertiser pays a fixed cost for a predetermined number (typically 1,000) of exposures of an advertisement. However, it has a drawback that an advertiser may pay for an advertisement even in a case where the advertisement is rarely exposed to the users. On the other hand, in the CPC method, an advertiser pays for the number of users' clicks on an advertisement. However, the CPC method has a drawback that an advertiser may pay an excessive amount of money for fraudulent clicks. Therefore, additional methods for determining the price of an advertisement on the Internet are needed.

### SUMMARY

A feature of an embodiment of the invention is to provide a method and system for determining the price of an advertisement based on both exposure and click based costs while reducing the effect of fraudulent clicks on the price.

In accordance with certain embodiments of the present invention, there is provided a hybrid advertisement pricing system and method. In some embodiments, a CPM price is calculated for one or more exposures of an advertisement, and a CPC price is calculated for one or more user clicks on the exposed advertisement. Then, a hybrid or composite price of the advertisement is determined based on the CPC price and the CPM price.

In one embodiment, the CPM price may be calculated by multiplying a predetermined price per exposure by a total number of exposures of an advertisement. Further, the CPC price is inversely proportional to the number of repeated fraud clicks, which may be calculated by using the equation “CPC price=price per click*e^{-r(n-1)n}”, wherein r is a coefficient for attenuating the effect of repeated fraudulent clicks, and n is the number of repeated clicks.

### BRIEF DESCRIPTION OF THE DRAWINGS

FIG. 1 shows a configuration of a network system including a hybrid advertisement pricing system in accordance with one embodiment of the present invention.

FIG. 2 shows a block diagram of an example hybrid advertisement pricing system in accordance with one embodiment of the present invention.

FIG. 3 shows an example of a running ads table in accordance with one embodiment of the present invention.

FIG. 4 illustrates graphs of CPC price that is calculated by considering the effect of repeated fraudulent clicks in accordance with one embodiment of the present invention.

FIG. 5 illustrates a flow chart of a method for counting the number of clicks in accordance with one embodiment of the present invention.

FIG. 6 shows another example of a running ads table in accordance with one embodiment of the present invention.

FIG. 7 illustrates a flow chart of a method for calculating price of an advertisement based on both CPM and CPC in accordance with one embodiment of the present invention.

FIG. 8 illustrates a computing system architecture, which may be used to implement a method or system according to one embodiment of the present invention.

### DESCRIPTION OF EXAMPLE EMBODIMENTS

Various embodiments of the present invention will be described in detail below with reference to accompanying drawings. It will be apparent, however, that these embodiments may be practiced without some or all of these specific details. In other instances, well known process steps or elements have not been described in detail in order not to unnecessarily obscure the description of the invention.

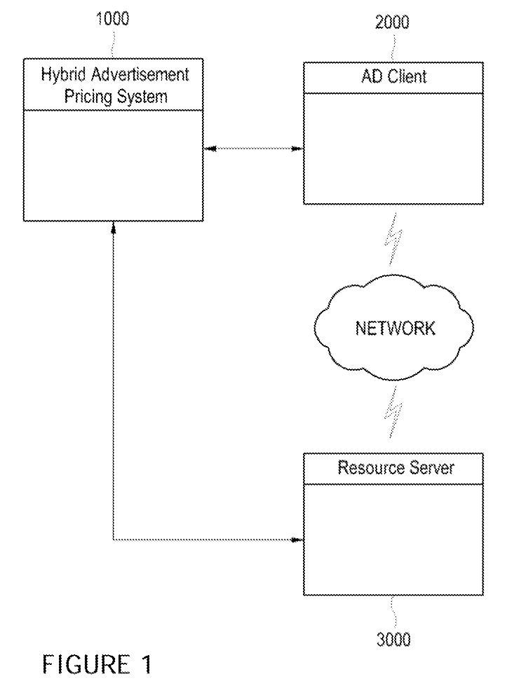

FIG. 1 shows a configuration of a network system including a hybrid advertisement pricing system in accordance with one embodiment of the present invention. As shown in FIG. 1, a hybrid advertisement pricing system 1000 and an advertisement client (hereinafter referred to as “AD client”) 2000 are interconnected to each other, and the AD client 2000 is connected to a resource server 3000 via a network such as the Internet. Also, the hybrid advertisement pricing system 1000 and the resource server 3000 is interconnected to each other.

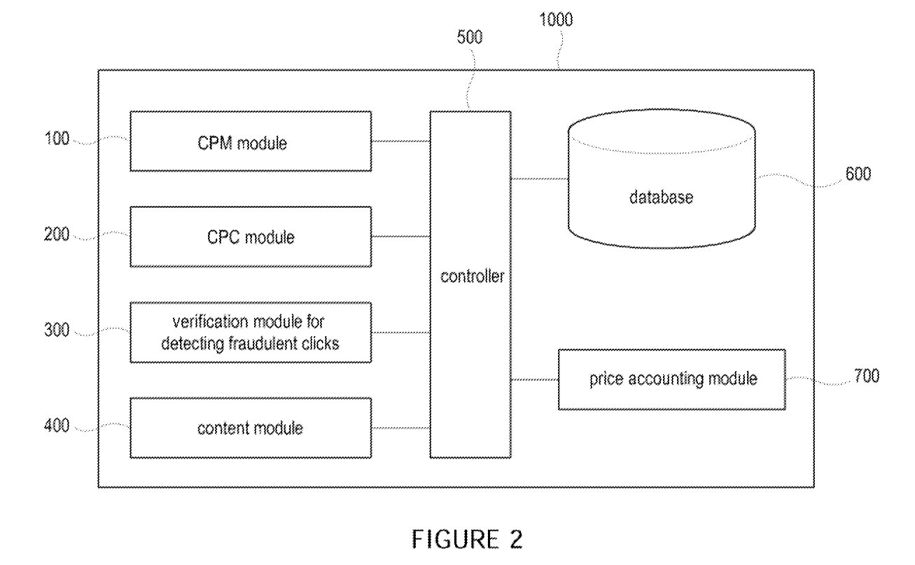

FIG. 2 shows a block diagram of the hybrid advertisement pricing system 1000 in accordance with one embodiment of the present invention. As shown in FIG. 2, the hybrid advertisement pricing system 1000 includes a CPM (Cost-Per-Million impressions) module 100, a CPC (Cost-Per-Click) module 200, a verification module for detecting fraudulent clicks 300, a content module 400, a controller 500, a database 600 and a price accounting module 700.

The CPM module 100 performs operations such as receiving an exposure request from the AD client 2000, generating a hybrid ID in response to the exposure request, and computing the price of an advertisement based on the number of exposures of the advertisement. In one embodiment, while the operations of receiving an exposure request and generating a hybrid ID in response thereto are performed in real time, the operation of computing the price may be performed in batch processes as needed or on a periodic basis (e.g., per one day, one week, or one month). Further, for the purpose of computing CPM price the in CPM module 100, information on the number of received exposure requests is stored in connection with Hybrid IDs.

Referring back to FIG. 1, if the advertisement is presented in connection with content (e.g., a webpage) that is provided by the resource server 3000, the AD client 2000 transmits an exposure request for an advertisement to the hybrid advertisement pricing system 1000. Then the CPM module 100 of the hybrid advertisement pricing system 1000 generates a hybrid ID in response to the exposure request and transmits it to the AD client 2000.

In one embodiment, the hybrid ID includes an advertisement ID having data fields such as “advertisement name,” “site name,” “content number,” “time stamp,” “user ID.” The “advertisement name” is a text or a serial number which is assigned to an advertisement, and the “site name” (e.g., “YAHOO”) indicates a name of an advertisement client such as the AD client 2000 Shown in FIG. 1. The “content number” indicates which of contents (e.g., webpages) provided by the resource server 3000 the advertisement is exposed on, and the “time stamp” indicates time when the advertisement is first exposed to a user. Further, the “user ID” is a unique number indicating a location or a user's terminal where the content including the advertisement is displayed. The “user ID” may be determined based a network address such as an IP address of the user's terminal. The user ID may also be based on a user identifier contained in a browser-cookie appended to the request messages transmitted from a browser or other client application of the end user. Accordingly, based on a user ID included in a hybrid ID, the AD client 2000 processes exposure requests for an advertisement from a plurality of users separately.

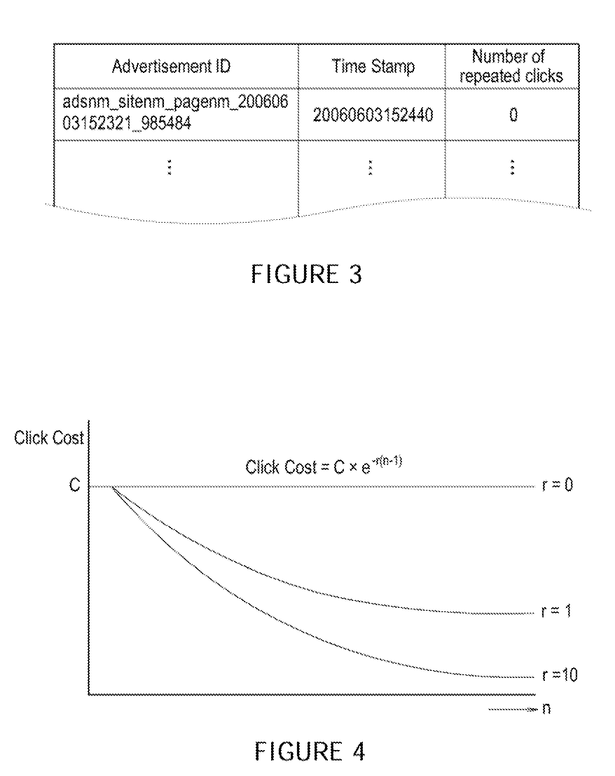

Further, the CPM module 100 adds the hybrid ID for the exposed advertisement to a running ads table stored in the database 600 upon the CPM module 100 receiving an exposure request. (Hereinafter, such a procedure for adding information to the running ads table is referred to as a generation event.) FIG. 3 shows an example of a running ads table including information on an exposed advertisement that is added according to a generation event in accordance with one embodiment of the present invention. As shown in FIG. 3, a running ads table stores a hybrid ID including an advertisement ID, time stamp and click counts. The time stamp indicates a point of time when the advertisement is exposed to a user, and the click counts indicates the number of user clicks on the advertisement. If any clicks have been not made on an advertisement since the advertisement is exposed, the click counts is marked as 0 as shown in FIG. 3.

The CPM module 100 also computes the price of an advertisement based on the number of exposures of the advertisement. In accordance with one embodiment of the present invention, the CPM module calculates the price of an advertisement by using the following equation (1).

CPM price=price per exposure*total number of exposures. (1)

Any suitable method or component for counting the number of exposures and determining the price per exposure could be used in the CPM module 100. For example, the price per exposure may be a fixed rate, or determined through a negotiation between an advertisement system provider and a user. In one embodiment, the CPM module 100 transmits a message (e.g., webpage) that suggests a price per exposure. In response to the suggestion, an advertiser would transmit to the CPM module 100 a message including information indicating acceptance or rejection of the suggested price. Such procedures are repeated until the agreement on price is made. The determined price per exposure is then stored in the database 600 together with its advertisement ID. Whenever the CPM module 100 receives an exposure request from the AD client 2000, the CPM module 100 increases the number of exposures by one.

Meanwhile, the CPC module 200 computes the price of the advertisement based on the number of clicks on the advertisement. For example, for each exposure of an advertisement, the price for the advertisement may be calculated based on the number of clicks as explained below.

In one embodiment of the present invention, the CPC module 200 calculates the price by using the following equation (2).

CPC price=price per click*e^{-r(n-1)} (2)

(r: coefficient for attenuating the effect of repeated fraudulent clicks, n: the number of repeated clicks)

In Equation (2), the price per click may be predetermined and stored in the database 600. The price per click may be determined in a similar way to those explained above with respect to the CPM module 100. Alternatively, the price per click may be determined through any suitable method for bidding for placement.

FIG. 4 illustrates graphs of CPC price that is calculated by considering the effect of repeated fraudulent clicks in accordance with one embodiment of the present invention. In FIG. 4, three graphs of Equation (2) are shown for r=0, 1 and 10, respectively. As shown, it is noted that as the value of r becomes greater, the price to be paid for repeated fraudulent clicks are greatly reduced. A suitable value for r may be predetermined by advertisers and advertisement service providers.

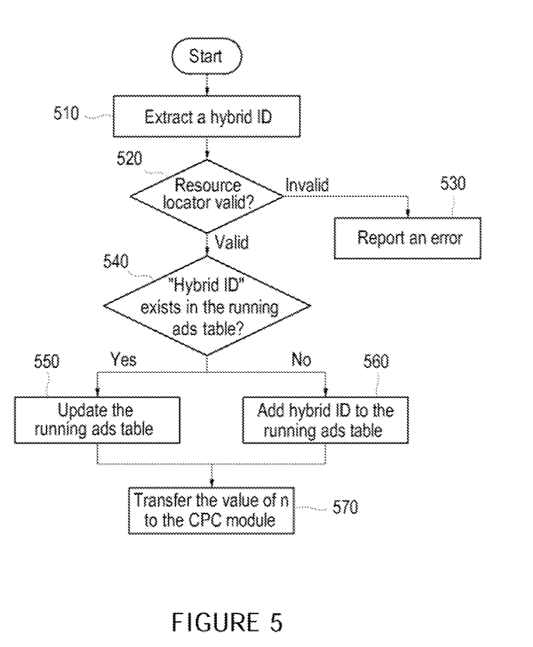

Referring to FIG. 2, the verification module 300 counts the number of repeated clicks, i.e. n in Equation (2). FIG. 5 illustrates a flow chart of a method for counting the number of repeated clicks in accordance with one embodiment of the present invention, which may be executed by the verification module 300.

For example, when a user clicks an advertisement exposed on content such as a webpage provided by the resource server 3000, a resource locator including a hybrid ID for the advertisement is transferred to the verification module 300. Then, the verification module 300 verifies the validity of the resource locator. In one embodiment, the verification module 300 maintains a list of valid resource servers, e.g., a list of codes unique for resource servers that are registered as providers for contents on which an advertisement is exposed. When a user clicks an advertisement, the verification module 300 checks if the resource server 3000 is included in the list of valid resource servers.

As a result of verification, if the received resource locator is determined to be invalid, the verification module 300 reports an error to the controller 500 (operation 530), so that the controller 500 would ignore the current click. As such, it is possible to prevent a fraudulent click by a user from affecting the price of the advertisement. On the other hand, in operation 520, if the received resource locator is determined to be valid, the verification module 300 checks whether the hybrid ID exists in a running ads table stored in the database 600 (operation 540).

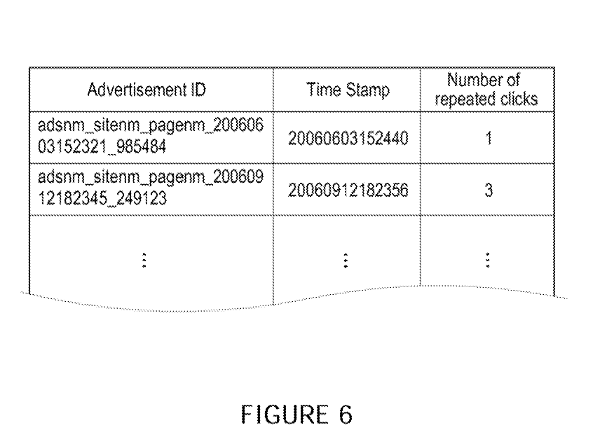

In operation 540, if it is determined that the hybrid ID exists in the running ads table, the verification module 300 updates the running ads table (operation 550). Particularly, in the running ads table, the time stamp is updated with the current time, and the click count (n in the Equation (2)) is increased by one. For example, if a user first clicks an advertisement associated with the hybrid ID as shown in FIG. 3, the click count of the running ads table is increased to be “1” as shown in FIG. 6. On the other hand, in operation 540, if it is determined that the hybrid ID does not exist in the running ads table, the verification module 300 adds the hybrid ID to the running ads table (operation 560).

The CPC module 200 may delete a hybrid ID that is stored in the running ads table if the advertisement associated with the hybrid ID has not been clicked since the current time (as updated in the time stamp of the running ads table) until a predetermined time (hereinafter referred to as “fraudulent check period”) elapses. Further, if the advertisement associated with the deleted hybrid ID is clicked afterwards, then the hybrid ID is re-inserted in the running ads table. In this case, the click count in the inserted information may be set to “1.” In one embodiment, the fraudulent check period is predetermined by a system administrator, which is stored in the database 600. By adjusting properly the fraudulent check period, it is possible to detect clicks that are made sequentially by a fraudulent user.

Referring back to FIG. 5, in operation 570, the counted click number n is transferred from the verification module 300 to the CPC module 200. Upon receiving each click number n, the CPC module 200 computes CPC price using Equation (2). That is, operation 570 is performed whenever the click count in the running ads table is modified or a new hybrid ID is added (or re-inserted) to the running ads table. Further, while operations 510 to 570 are performed in real time, the CPC module 200 may compute CPC price in batch processes as needed or on a periodic basis.

For computing CPC price in batch processes, a list of the counted click number may be stored with corresponding Hybrid ID in the running ad table, based on which the CPC module 200 computes a CPC price for each click count. The CPC module 200 then forwards the computed CPC prices to the price accounting module 700 through the controller 500 with the associated advertisement ID. In this way, the price accounting module 700 adds up the advertisement prices associated with a certain advertisement ID, which are transferred from the CPC module 200. For example, if a user first clicks an advertisement exposed on a content such as a webpage, the verification module 300 executes operations 510 to 570 as shown in FIG. 5 to output “1” as the click number n to the CPC module 200. Then, the CPC module 200 computes CPC price by applying n=1 to Equation (2), which is forwarded to the price accounting module 700 together with the associated advertisement ID. Thereafter, if another click is made on the advertisement, the verification module 300 executes operations 510 to 570 again to output n=2 to the CPC module 200. Then, the CPC module 200 computes CPC price for n=2, which is sent to the price accounting module 700 with the associated advertisement ID. The price accounting module 700 sums up the computed prices associated with the same advertisement ID, thereby obtaining total CPC price for one exposure of the advertisement. The above-described procedure can be represented by the following equation (3).

$$Total CPC Price = {\sum }_{k = 1}^{n} CPC Price ( k ) \qquad ( 3 )$$

In the following, embodiments of a hybrid advertisement pricing method will be described in detail. In certain embodiments, the hybrid advertisement pricing method calculates the price of an advertisement based on both CPM and CPC. First, a CPM price is calculated for one or more exposures of an advertisement using Equation (1). Then, CPC prices are calculated for the exposures of the advertisement using Equations (2) and (3). Then, a total price for the advertisement is determined by adding the CPM and CPC prices.

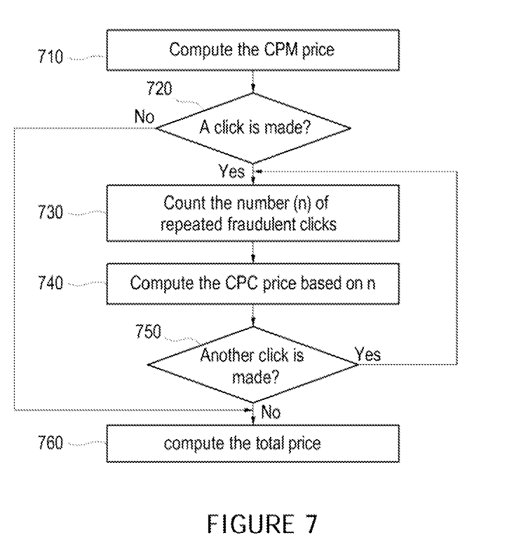

FIG. 7 illustrates a flow chart of a method for calculating price of an advertisement based on both CPM and CPC in accordance with one embodiment of the present invention. As shown in FIG. 7, a hybrid pricing system such as the hybrid advertisement pricing system 1000 (FIG. 1) computes a CPM price for an exposed advertisement (operation 710). In one embodiment, a CPM module such as the CPM module 100 (FIG. 2) computes the CPM price and transmits the computed CPM price to a price accounting module such as the price accounting module 700 (FIG. 2). In operation 720, it is checked whether a click is made on the exposed advertisement. For example, such operation may be performed based on whether a verification module such as the verification module 300 (FIG. 2) receives a valid resource locator (e.g., URL) from a resource server such as the resource server 3000 (FIG. 1). As a result of operation 720, if it is determined that any click is not made on the advertisement, it proceeds to operation 760. In operation 760, a total price for the advertisement is determined. In this case, the total price is determined based on only the CPM price, i.e., the price for one exposure of the advertisement.

On the other hand, in operation 720, if it is determined that a click is made on the advertisement, the number of repeated fraudulent clicks on the advertisement is counted (operation 730). In one embodiment, a verification module such as the verification module 300 (FIG. 2) counts the number of repeated fraudulent clicks and transmits the counted number to a CPC module such as the CPC module 200 (FIG. 2). Then, a CPC price for the advertisement is determined based on the counted number of repeated fraudulent clicks (operation 740). For example, a CPC module such as the CPC module 200 (FIG. 2) may compute the CPC price based on the counted number and transmit the computed CPC price to a price account module such as the price accounting module 700 (FIG. 2). Thereafter, in operation 750, it is checked whether another click is made on the advertisement. If it is determined that another click is made, operations 730 and 740 are repeated. For example, if three clicks are subsequently made on the advertisement, the CPC prices calculated by applying n=1, n=2 and n=3 to Equation (2) are stored in a price accounting module such as the price accounting module 700 (FIG. 2), respectively.

In operation 750, if it is determined that another click is not made on the advertisement, a total price for the advertisement is calculated based on the CPM and CPC prices (operation 760). Operation 750 may be performed by checking if the advertisement has not been clicked since the latest click was made until the fraudulent check period elapses. In another possible implementation of the invention, the CPC module may sum up the total number of user clicks (n) corresponding to a given Hybrid ID, apply n to Equation (2) to get CPC price and multiply the computed CPC price by n to obtain a CPC price for the series of clicks associated with that Hybrid ID.

For example, a price accounting module such as the price accounting module 700 (FIG. 2) may compute the total price of the advertisement. The total price may be determined by adding up the CPM price for one or more exposures of the advertisement and the CPC prices calculated for the counted clicks for the exposures. For example, when clicks are made n times for one exposure of an advertisement, the total price would be determined as follows (4).

$$Total Price = CPM price per one exposure + {\sum }_{k = 1}^{n} CPC Price ( k ) \qquad ( 4 )$$

The operations illustrated in FIG. 7 may be executed for each exposure of an advertisement. That is, whenever an advertisement is exposed to a user, operations 710 to 760 as shown in FIG. 7 may be executed to calculate a total price for the advertisement for each exposure. Further, a total price for more than one exposures of an advertisement may be determined by adding the total prices for the exposures, each being calculated using Equation (4).

In some embodiments of the present invention, the verification module has been described to detect fraudulent clicks by using a list of valid resource locators (or valid resource servers) and the fraudulent check period. However, any other suitable methods such as statistical modeling techniques for detecting fraudulent clicks may be applied to the present invention.

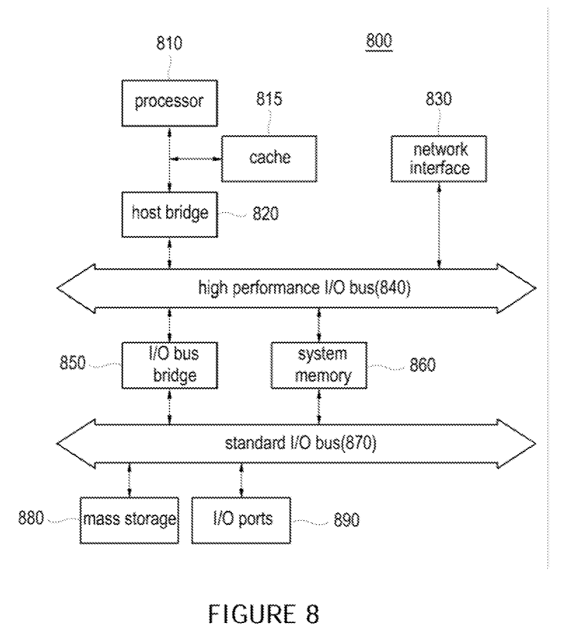

While the methods and systems of the present invention have been described above with reference to specific embodiments, some or all of the elements or operations thereof may be implemented using a computer system having a general purpose hardware architecture. FIG. 8 illustrates an example computing system architecture, which may be used to implement one or more of the operations or elements described herein. In one implementation, hardware system 800 comprises a processor 810, a cache memory 815, and one or more software applications and drivers directed to the functions described herein.

Additionally, hardware system 800 includes a high performance input/output (I/O) bus 840 and a standard I/O bus 870. A host bridge 820 couples processor 810 to high performance I/O bus 840, whereas I/O bus bridge 850 couples the two buses 840 and 870 to each other. A system memory 860 and a network/communication interface 830 are coupled to bus 840. Hardware system 800 may further include video memory (not shown) and a display device coupled to the video memory. Mass storage 830 and I/O ports 890 are coupled to bus 870. Hardware system 800 may optionally include a keyboard and pointing device, and a display device (not shown) coupled to bus 870. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 800 are described in greater detail below. In particular, network interface 830 provides communication between hardware system 800 and any of a wide range of networks, such as an Ethernet (e.g., IEEE 802.3) network, etc. In the case of the hybrid advertisement pricing system 1000, the network interface 830 interfaces between the hardware system 800 and the network for allowing the hardware system 800 to manage those databases. Mass storage 830 provides permanent storage for the data and programming instructions to perform the above described functions implemented in the hybrid advertisement pricing system 1000, whereas a system memory 860 (e.g., DRAM) provides temporary storage for the data and programming instructions when executed by processor 810. I/O ports 890 are one or more serial and/or parallel communication ports that provide communication between additional peripheral devices, which may be coupled to hardware system 800.

Hardware system 800 may include a variety of system architectures; and various components of hardware system 800 may be rearranged. For example, cache 815 may be on-chip with processor 810. Alternatively, cache 815 and processor 810 may be packed together as a “processor module,” with processor 810 being referred to as the “processor core.” Furthermore, certain implementations of the present invention may not require nor include all of the above components. For example, the peripheral devices shown coupled to standard I/O bus 870 may couple to high performance I/O bus 840. In addition, in some implementations only a single bus may exist, with the components of hardware system 800 being coupled to the single bus. Furthermore, hardware system 800 may include additional components, such as additional processors, storage devices, or memories. As discussed below, in one embodiment, the operations of the integrated search system described herein are implemented as a series of software routines run by hardware system 800. These software routines comprise a plurality or series of instructions to be executed by a processor in a hardware system, such as processor 810. Initially, the series of instructions are stored on a storage device, such as mass storage 830. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 830. The instructions are copied from the storage device, such as mass storage 830, into memory 860 and then accessed and executed by processor 810.

An operating system manages and controls the operation of hardware system 800, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

According to embodiments of the present invention, the hybrid advertisement pricing systems provide a method of determining a price of an advertisement by reducing the effect of fraudulent clicks on the price of the advertisement. Therefore, by employing the systems and methods of the embodiments, it is possible for advertisement service provider to enhance advertising market on the Internet and improve profits by attracting more advertisers.

While the present invention has been shown and described with respect to a preferred embodiment, those skilled in the art will recognize that various changes and modifications may be made without departing from the spirit and scope of the invention as defined in the appended claims.

1. A hybrid advertisement pricing system, comprising:
a CPM module configured to compute a CPM price for one or more exposures of an advertisement;
a CPC module configured to compute a CPC price for one or more user clicks on the exposed advertisement; and
a price accounting module configured to calculate a total price of the advertisement based on the CPC price and the CPM price.

2. The system of claim 1, wherein the CPM module computes the CPM price by using the following equation: CPM price=price per exposure * total number of exposures.

3. The system of claim 1, wherein the CPC module computes the CPC price by using the following equation:
CPC price=price per click*e^{-r(n-1)} ,
wherein r is a coefficient for attenuating the effect of repeated fraudulent clicks, and n is the number of repeated clicks.

4. The system of claim 1, further comprising:
an AD client configured to transmit an exposure request to the CPM module whenever the advertisement is exposed to a user,
wherein in response to the exposure request, the CPM module generates a hybrid ID including information on an ID of the advertisement, a location of the advertisement, time when the advertisement is exposed, and the number of repeated clicks on the advertisement.

5. The system of claim 4, wherein if the CPM module receives an exposure request from the AD client, the CPM module increases the number of exposures of the advertisement by one, and computes the CPM price based on the number of exposures.

6. The system of claim 4, wherein if a click is made on the advertisement within a predetermined period from a previous click on the advertisement, the CPC module increases the number of repeated clicks in the hybrid ID, and computes the CPC price based on the number of repeated clicks.

7. The system of claim 6, wherein the CPC price is inversely proportional to the number of repeated clicks.

8. The system of claim 7, wherein the CPC price is determined using the following equation:
CPC price=price per click*e^{-r(n-1)},
wherein r is a coefficient for attenuating the effect of repeated fraudulent clicks, and n is the number of repeated clicks.

9. The system of claim 4, further comprising:
a verification module configured to check if the exposure of the advertisement is valid, wherein if the verification module determines that the the exposure of the advertisement is valid and a click is made on the advertisement within a predetermined period from a previous click on the advertisement, the CPC module increases the number of repeated clicks in the hybrid ID.

10. The system of claim 9, wherein the verification module determines whether the hybrid ID of the advertisement is stored in a running ads table, and if the hybrid ID exists in the running ads table, updating the hybrid ID in the running ads table, and otherwise, adding a new hybrid ID for the advertisement to the running ads table.

11. The system of claim 10, wherein the CPC module deletes a hybrid ID that is stored in the running ads table if the advertisement associated with the hybrid ID has not been clicked after current time represented by the time stamp of the hybrid ID until a predetermined time elapses.

12. The system of claim 10, wherein the verification module transfers the number of repeated clicks in the hybrid ID stored in the running ads table to the CPC module to compute the CPC price based on the number of repeated clicks.

13. The apparatus of claim 1, wherein the price accounting module computes the total price of the advertisement using the following equation:
$$Total Price = CPM P rice + {\sum }_{k = 1}^{n} CPC Price ( k ) ,$$
wherein n is the number of repeated clicks.

14. A hybrid advertisement pricing method, comprising:
computing a CPM price for one or more exposures of an advertisement;
computing a CPC price for one or more users′ clicks on the exposed advertisement; and
calculating a total price of the advertisement based on the CPC price and the CPM price.

15. (canceled)

16. The method of claim 14, wherein the operation of computing the CPC price includes computing the CPC price using the following equation:
CPC price=price per click*e^{-r(n-1)},
wherein r is a coefficient for attenuating the effect of repeated fraudulent clicks, and n is the number of repeated clicks.

17. The method of claim 14, further comprising:
generating a hybrid ID for the advertisement whenever the advertisement is exposed to a user,
wherein the hybrid ID includes information on an ID of the advertisement, a location of the advertisement, time when the advertisement is exposed, and the number of repeated clicks on the advertisement.

18. The method of claim 17, further comprising:
increasing the number of exposures of the advertisement by one whenever the advertisement is exposed to a user; and
computing the CPM price based on the number of exposures.

19. The method of claim 14, further comprising:
increasing the number of repeated clicks in the hybrid ID if a click is made on the advertisement within a predetermined period from a previous click on the advertisement; and
computing the CPC price based on the number of repeated clicks.

20. The method of claim 19, wherein the CPC price is inversely proportional to the number of repeated clicks.

21. The method of claim 19, wherein the CPC price is determined using the following equation:
CPC price=price per click*e^{-r(n-1)}
wherein r is a coefficient for attenuating the effect of repeated fraudulent clicks, and n is the number of repeated clicks.

22. The method of claim 17, further comprising:
checking if the exposure of the advertisement is valid; and
if it is determined that the exposure of the advertisement is valid and a click is made on the advertisement within a predetermined period from a previous click on the advertisement, increasing the number of repeated clicks in the hybrid ID.

23. The method of claim 22, further comprising:
determining whether the hybrid ID of the advertisement is stored in a running ads table;
if it is determined that the hybrid ID exists in the running ads table, updating the hybrid ID in the running ads table, and otherwise, adding a new hybrid ID for the advertisement to the running ads table.

24. The method of claim 23, further comprising:
deleting a hybrid ID that is stored in the running ads table if the advertisement associated with the hybrid ID has not been clicked after current time represented by the time stamp of the hybrid ID until a predetermined time elapses.

25. The method of claim 14, wherein the total price of the advertisement is computed using the following equation:
$$Total Price = CPM P rice + {\sum }_{k = 1}^{n} CPC Price ( k ) ,$$
wherein n is the number of repeated clicks.

26. Logic encoded in one or more tangible media for execution and when executed operable to cause the one or more processors to:
compute a CPM price for one or more exposures of an advertisement;
compute a CPC price for one or more users′ clicks on the exposed advertisement; and
calculate a total price of the advertisement based on the CPC price and the CPM price.
